(19) United States
(12) Patent Application Publication
(10) Pub. No.: US 2006/0290740 A1
(43) Pub. Date: Dec. 28, 2006

(54) Liquid ejecting apparatus

(75) Inventor: Fujio Akahane, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/473,033

(22) Filed: Jun. 23, 2006

(30) Foreign Application Priority Data
Jun. 23, 2005 (JP) P2005-182971

(51) Int. Cl. B41J 2/15

(52) U.S. Cl. 347/40

(57) ABSTRACT

A liquid ejecting apparatus includes a head group. The head group includes a first array, including: a first nozzle array and a second nozzle array, each of which is operable to eject first liquid and extends in a first direction, and which are arranged in the first direction and define a first gap therebetween; and a second array including: a third nozzle array and a fourth nozzle array, each of which is operable to eject second liquid and extends in the first direction, and which are arranged in the first direction and define a second gap therebetween. The first and second arrays are arranged in a second direction perpendicular to the first direction, and the first and second gaps are not overlapped in the second direction. The head group includes a fifth nozzle array, operable to eject the first and second liquid and disposed so as to correspond to the first and second gaps in the second direction.

### BACKGROUND OF THE INVENTION

The present invention relates to a liquid ejecting apparatus which ejects a liquid, which is supplied from a liquid cartridge etc., as liquid droplets, and particularly to a liquid ejecting apparatus for which, in a head unit mounting a plurality of unit heads, it is possible to reduce the width of the head unit.

As one kind of liquid ejecting apparatus, there is an inkjet recording apparatus. Such an inkjet recording apparatus ejects ink liquid droplets from thin nozzles arrayed on a printer head, causing the ink liquid droplets to impact on a recording medium such as a recording paper, thereby recording a character, an image or the like in the form of dots. A feature of the inkjet recording apparatus is that a recording cost is low and a colorization is easy.

As a recording head of the inkjet recording apparatus, there are a so-called serial head, length of which is shorter than a page width of the recording paper, and a so-called line head, which has a length substantially the same as the page width of the recording paper. Of these heads, it is a feature of the line head that, since it does not need to be moved in a page width direction of the recording paper by drive means, such as a motor, during a recording, as in the serial head, there is no need to provide the drive means, and it is easy to reduce a printer body in size, cost and the like.

The line head is one in which ejection nozzles of a width equivalent to a printing width with respect to a recording paper are arranged in order, for each color array, in a direction substantially perpendicular to a transport direction of the recording paper, and ink liquid droplets are selectively ejected from the individual ejection nozzles while the recording paper is being transported, and caused to impact on the recording paper.

An inkjet recording apparatus equipped with such a line head is disclosed in JP-A-2004-50445 described hereafter.

FIG. 9 shows a line head 70 of the apparatus shown in JP-A-2004-50445. The line head 70 has a chip line 75 formed by staggering head chips 72, each of which is formed with one nozzle array 71, in such a way that the nozzle arrays 71 are arranged in a paper width direction (a direction perpendicular to a traveling direction of a recording medium).

However, the related apparatus, although carrying out a color printing with inks of four colors, yellow (Y), magenta (M), cyan (C) and black (B), needs to form chip lines 75Y, 75M, 75C and 75B having the head chips 72 staggered for each color. Consequently, a head chip 72 array of a width twice the number of colors is required and, in a recording apparatus which ejects four color inks as in this example, the width (a dimension of the a recording medium in a transport direction) of the line head 70 requires at least a width equivalent to eight arrays of the head chips 72. Recently, an apparatus, which carries out a color printing with multicolor inks of six colors or eight colors, has been developed aiming at a further improvement in color image quality. However, the related line head 70 has a problem in which, as its width dimension becomes equal to or greater than the head chip 72 array of a width twice the number of colors as described heretofore, it is impossible to avoid an increase in the size of the apparatus.

### SUMMARY

It is therefore an object of the invention to provide a liquid ejecting apparatus for which, in a head unit mounting a plurality of unit heads, it is possible to reduce the width of the head unit.

In order to achieve the object, according to the invention, there is provided a liquid ejecting apparatus comprising:

a head group, including:
a first array, including:
   a first nozzle array and a second nozzle array, each of which is operable to eject first liquid and extends in a first direction, and which are arranged in the first direction and define a first gap therebetween; and
a second array including:
   a third nozzle array and a fourth nozzle array, each of which is operable to eject second liquid and extends in the first direction, and which are arranged in the first direction and define a second gap therebetween;
wherein the first and second arrays are arranged in a second direction perpendicular to the first direction, and
wherein the first and second gaps are not overlapped in the second direction; and
a fifth nozzle array, operable to eject the first and second liquid and disposed so as to correspond to the first and second gaps in the second direction.

The first liquid may be different from the second liquid.

The fifth nozzle array may include a sixth nozzle array operable to eject the first liquid and a seventh nozzle array operable to eject the second liquid which are arranged in the first direction.

Length of the first gap may be substantially identical with length of the sixth nozzle array, and length of the second gap may be substantially identical with length of the seventh nozzle array.

Sum of length of the first gap and length of the second gap may be no more than length of the fifth nozzle array, and size of each of unit heads, which have the first, second, third and fourth nozzle arrays, respectively, may be identical with size of a complementary head having the fifth nozzle array.

A plurality of the head groups may be arranged in the first direction.

A plurality of the head groups may be arranged in the second direction.

### BRIEF DESCRIPTION OF THE DRAWINGS

FIG. 1 is a schematic configuration view showing an example of a recording apparatus to which the invention is applied.

FIG. 2 is a schematic configuration view of the recording apparatus.

FIG. 3 is a view of a line head as seen from a nozzle surface side.

FIG. 4 is an exploded perspective view showing a unit head.

FIG. 5 is a sectional view showing the unit head.

FIG. 6 is an exploded perspective view showing a complementary head.

FIG. 7 is an enlarged view of the line head as seen from a nozzle surface side.

FIG. 8 is a view showing a second example of the line head.

FIG. 9 is a view showing a related example.

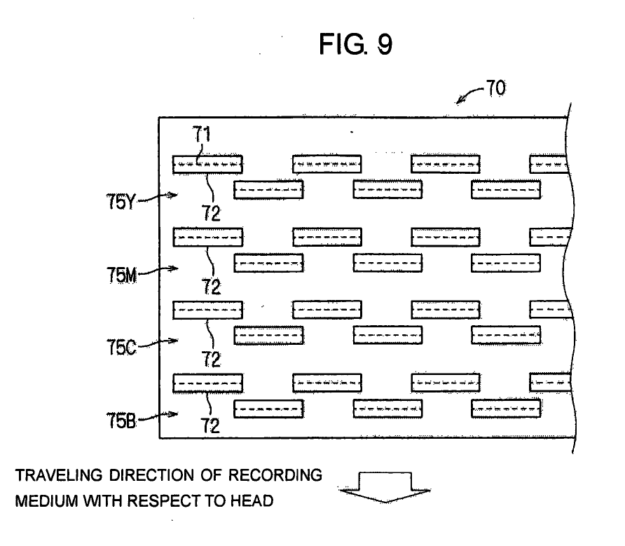

### DETAIL DESCRIPTION OF PREFERRED EMBODIMENTS

Next, an embodiment of the invention will be described in detail.

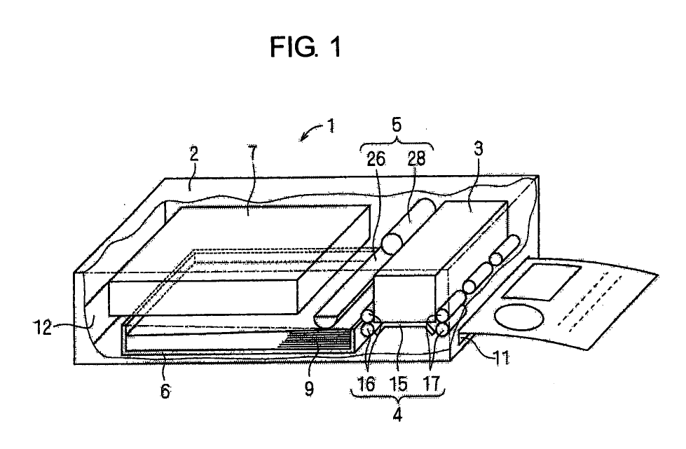

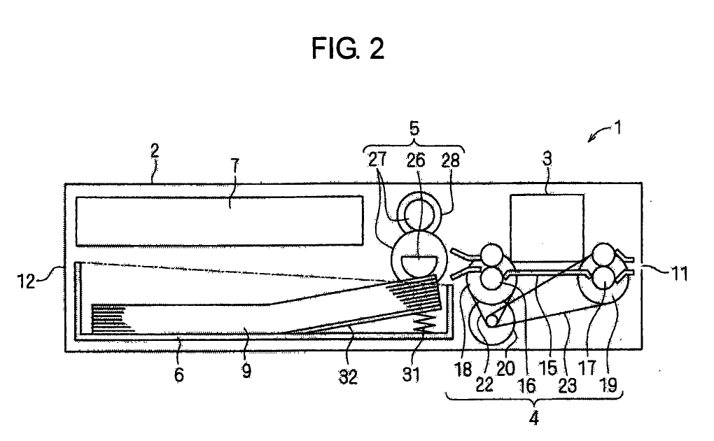

FIG. 1 and FIG. 2 show an example of a peripheral structure of an inkjet recording apparatus to which the liquid ejecting apparatus of the invention is applied. In this example, a description will be given of an example in which the invention is applied to a line head recording apparatus equipped with a line head having a recording range of substantially the same dimension as a page width of a recording paper 9.

The recording head 1 is provided, inside a casing 2 forming an exterior thereof, with the line head 3 having the recording range of substantially the same dimension as the page width of the recording paper 9, a transport section 4 which transports the recording paper 9 in a prescribed direction, a paper feeding section 5 which feeds the recording paper 9 to the line head 3, a paper tray 6 which stores the recording paper 9, and an electric circuit 7 which controls a driving of these components.

The casing 2 has, for example, a rectangular parallelepiped shape. A paper discharge opening 11, through which the recording paper 9 is discharged, is provided on one of side surfaces of the casing 2, and a tray in/out opening 12 to which the paper tray 6 is removably attached is provided on another side surface opposite the one side surface.

The line head 3 is configured to eject inks of four colors, for example, CMYK (cyan, magenta, yellow and black). The line head 3 is located in an inner-end upper portion of the casing 2 on a side of the paper discharge opening 11, with ejection nozzles, not shown here, directed downward.

The transport section 4 is equipped with a paper transport guide 15 forming a supply path transporting the recording paper 9, paper transport rollers 16 and 17 which transport the recording paper 9 by nipping it therebetween, to-be-described pulleys 18 and 19, and belts 22 and 23 for transmitting drive of a paper transport motor 20 to the pulleys 18 and 19. The transport section 4 is located in an inner-end lower portion of the casing 2 on the side of the paper discharge opening 11.

The paper transport guide 15, being formed as a flat plate, is spaced a prescribed distance below the line head 3. The paper transport rollers 16 and 17, each being made up of a pair of rollers in contact with each other, are located on both sides of the paper transport guide 15, i.e., on the tray in/out opening 12 side and the paper discharge opening 11 side, respectively. The paper transport motor 20, being located below the paper transport guide 15, is connected to the paper transport rollers 16 and 17 via the pulleys 18 and 19 and the belts 22 and 23.

The paper feeding section 5 is equipped with a paper feeding roller 26 for feeding the recording paper 9 to the transport section 4, a paper feeding motor 28 serving as a driving source which rotationally drives a to-be-described gear 27, and the gear 27 which is rotationally driven by the paper feeding motor 28. The paper feeding section 5 is located on a tray in/out opening 12 side with respect to the transport section 4. The paper feeding roller 26, having an approximate semicylindrical shape, is located in proximity to the paper transport rollers 16 on the tray in/out opening 12 side. The paper feeding motor 28, being located above the paper feeding roller 26, is connected to the paper feeding roller 26 via the gear 27.

The paper tray 6, which is formed as a box capable of storing the recording paper 9 of, for example, A4 size stacked one sheet on another, and in one end portion of the bottom of which is provided a paper support 32 retained by a spring 31, is attached in a space from a portion below the paper feeding section 5 to the tray in/out opening 12.

The electric circuit 7, being a section which controls the driving of each component, is located above the paper tray 6.

Such a recording apparatus 1 carries out a printing operation in the following manner.

First, a user turns on the recording apparatus 1, draws the paper tray 6 from the tray in/out opening 12, stores therein a prescribed number of sheets of recording paper 9, and pushes in the paper tray 6, thereby attaching the paper tray 6. Then, in the recording apparatus 1, by an urging force of the spring 31 causing the paper support 32 to lift one end of the recording paper 9, the one end of the recording paper 9 is pressed against the paper feeding roller 26. Then, as the paper feeding roller 26 is rotationally driven by the drive of the paper feeding motor 28, one sheet of recording paper 9 is fed from the paper tray 6 to the paper transport rollers 16.

Subsequently, in the recording apparatus 1, the paper transport rollers 16 and 17 are rotationally driven by the drive of the paper transport motor 20, and the paper transport rollers 16 nip the recording paper 9 fed from the paper tray 6 therebetween, thereby transporting the recording paper 9 to the paper transport guide 15. Then, in the recording apparatus 1, the line head 3 operates at a prescribed timing to eject ink droplets from the ejection nozzles, causing them to impact on the recording paper 9, thereby recording information including a character, an image etc. on the recording paper 9 in the form of dots. Then, in the recording apparatus 1, the paper transport rollers 17 nip the recording paper 9 transported along the paper transport guide 15 therebetween, thereby discharging the recording paper 9 from the paper discharge opening 11.

The recording apparatus 1 repeats such an operation until the recording is complete, thereby generating a print.

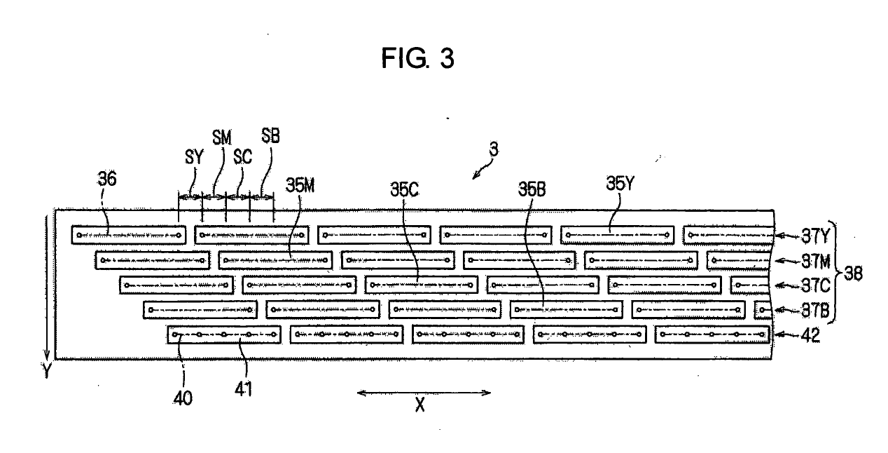

FIG. 3 shows the line head 3 as seen from the nozzle side.

The line head 3 is configured in such a way that unit heads 35 having a prescribed number of nozzles are arranged in line in a paper width direction (an X direction). The unit heads 35 include, in this example, four kinds, a unit head 35Y which ejects a yellow ink, a unit head 35M which ejects a magenta ink, a unit head 35C which ejects a cyan ink, and a unit head 35B which ejects a black ink. A plurality of each of the unit heads 35Y, 35M, 35C and 35B are prepared for each kind of ink to be ejected. The line head 3 is also equipped with a complementary head 41 having a complementary nozzle array 40 which ejects the four color inks.

In the line head 3, a head array 35Y, 35M, 35C, 35B of each color is formed by arranging the unit heads 35Y, 35M, 35C, 35B of each color, each of which is formed with a nozzle array 36 having liquid ejecting nozzles, in series in a direction of a nozzle array 36 (a nozzle array 36 direction). A plurality (in this example, four kinds) of the head arrays 35Y, 35M, 35C and 35B are provided, one for each color of ink to be ejected.

Also, the plurality of head arrays 35Y, 35M, 35C and 35B are arranged so as to be displaced in the nozzle array 36 direction so that a gap SY, SM, SC, SB between the nozzle arrays 36 of unit heads 35Y, 35M, 35C, 35B adjacent to each other in the nozzle array 36 direction in one of the individual color head arrays 37Y, 37M, 37C and 37B does not overlap that in another as seen in a direction perpendicular to the nozzle array 36. A main head group 38 is formed of the thus arranged individual color head arrays 37Y, 37M, 37C and 37B.

Furthermore, the line head 3 is equipped with the complementary head 41 which ejects the individual inks, which are ejected from the respective head arrays 37Y, 37M, 37C and 37B, so as to complement the gap SY, SM, SC, SB between the nozzle arrays 36 of the adjacent unit heads 35Y, 35M, 35C, 35B in each of the head arrays 37Y 37M, 37C and 37B in the main head group 38. The complementary nozzle array 40 of the complementary head 41 is configured to eject a plurality (in this example, four) of colors of ink to be ejected from the respective head arrays 37Y 37M, 37C and 37B.

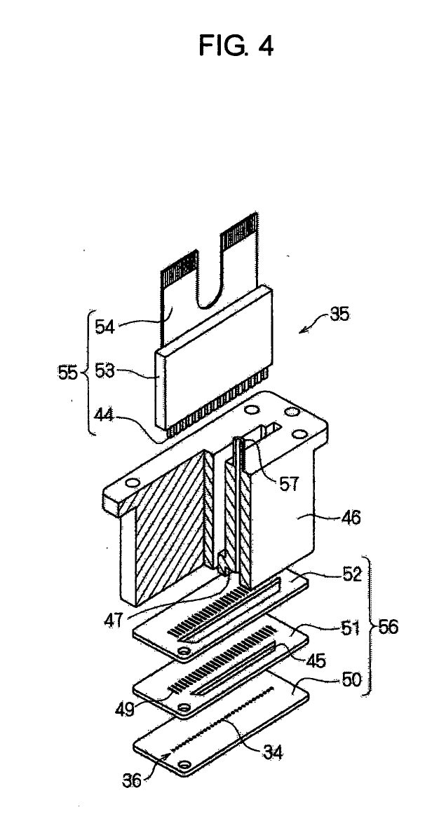

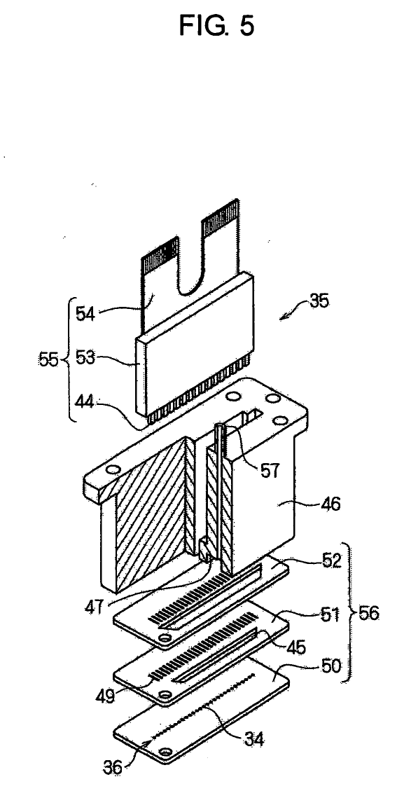

FIG. 4 and FIG. 5 show the unit head 35.

As shown in the figures, the unit head 35 is equipped with a head casing 46 in which a piezoelectric vibrator 44 serving as pressure generating means is stored, and a flow channel unit 56 which is fixed by an adhesive etc. to an unit fixation surface of the head casing 46.

The flow channel unit 56 is formed by laminating a flow channel formation substrate 51 formed with a flow channel space including a pressure generating chamber 49, a nozzle plate 50 being laminated to one surface of the flow channel formation substrate 51 and being formed with a nozzle 34 which ejects an ink in the pressure generating chamber 49, and a vibration plate (sealing plate) 52 being laminated to the other surface of the flow channel formation substrate 51 and sealing the flow channel space including the pressure generating chamber 49.

The nozzle plate 50, having one nozzle array 36 formed by arraying a plurality of the nozzles 34 at a pitch P corresponding to a prescribed resolution (dot pitch), is configured to eject ink droplets from each nozzle 34. The nozzle plate 50 is formed from a stainless steel plate.

The pressure generating chambers 49 in communication with each of the nozzles 34 are arranged in the flow channel formation substrate 51. Also, a damper chamber 45 for releasing a pressure fluctuation of a to-be-described ink reservoir 47 is formed in the flow channel formation substrate 51. Spaces to provide the pressure generating chambers 49 and the damper chamber 45 are formed as recesses on a vibration plate 52 side of the flow channel formation substrate 51. The flow channel formation substrate 51 is formed by etching, in this example, a silicon single crystal substrate.

The vibration plate 52, being made of a polyphenylene sulfide film, is formed by laminating an island portion 43 made of a stainless steel plate and the like. Also, the vibration plate 52 is formed with an ink supply opening 48 for supplying each pressure generating chamber 49 with ink in the to-be-described ink reservoir 47.

The flow channel unit 56 is formed by laminating the nozzle plate 50 to one surface of the flow channel formation substrate 51, and by laminating the vibration plate 52 to the other surface with the island portion 43 disposed on the outer side. The flow channel formation substrate 51, the nozzle plate 50 and the vibration plate 52 are coated with the adhesive, bonded by heating and maintaining them at a prescribed high temperature, and thereafter cooled down to a room temperature, thereby forming the flow channel unit 56.

In contrast, the head casing 46 is formed by injection molding a thermosetting resin or a thermoplastic resin, in the unit fixation surface of which the common ink reservoir 47, which stores ink to be supplied to each pressure generating chamber 49, is formed corresponding to a line of the pressure generating chambers 49 in such a way that it is located along the line of the pressure generating chambers 49. Also, the head casing 46 is formed with one ink supply path 57 which supplies ink to the ink reservoir 47.

Also, the head casing 46, being formed with a vertically penetrating storage space 58 extending in the nozzle array 36 direction, is configured in such a way that a vibrator unit 55 is stored in the storage space 58.

The vibrator unit 55 is formed by fixing the bar-shaped piezoelectric vibrators 44, arranged corresponding to the pressure generating chambers 49, to the leading end of a stationary plate 53, and connecting a flexible cable 54, for inputting an ejection signal, to each piezoelectric vibrator 44. The piezoelectric vibrators 44 are piezoelectric vibrators 44 of longitudinal vibration mode.

With the vibration plate 52 of the flow channel unit 56 bonded by the adhesive to the unit fixation surface of the head casing 46, the leading end face of the piezoelectric vibrator 44 is fixed to the island portion 43 of the vibration plate 52, and the stationary plate 53 is adhesively fixed to the head casing 46, thereby forming the unit head 35.

In the unit head 35 of the configuration described heretofore, a drive signal generated by the drive circuit is input to the piezoelectric vibrator 44 via the flexible cable 54, thereby extending and contracting the piezoelectric vibrator 44 in a longitudinal direction. The unit head 35 is configured in such a way that the island portion 43 of the vibration plate 52 is vibrated by the expansion and contraction of the piezoelectric vibrator 44 to vary a pressure in the pressure generating chamber 49, thereby ejecting the ink in the pressure generating chamber 49 from the nozzle 34 in the form of ink droplets.

The unit heads 35 are prepared for each of the inks of four colors, yellow (Y), magenta (M), cyan (C) and black (B), thus forming the head arrays 37Y, 37M, 37C and 37B which eject the yellow (Y), magenta (M), cyan (C) and black (B) color inks respectively. The main head group 38 is formed of the four head arrays 37Y, 37M, 37C and 37B.

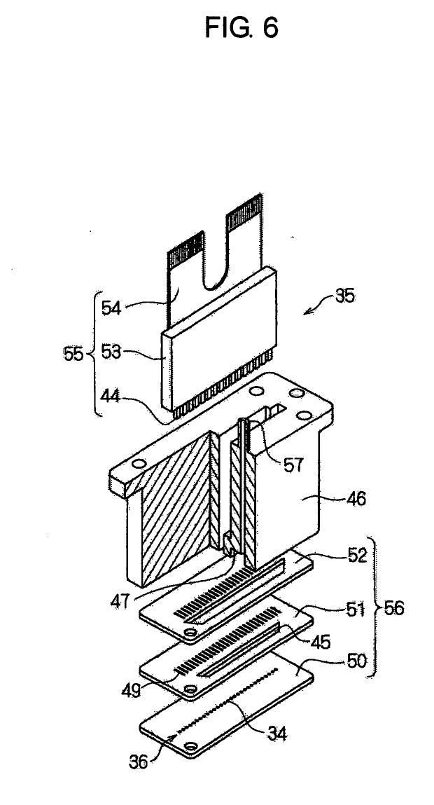

FIG. 6 shows the complementary head 41.

The complementary head 41 has the same ejection principle and basic structure as the unit head 35, and employs the size and dimension, as well as the material etc. of each member, which are also basically the same as those of the unit head 35.

In the unit head 35, one kind of (one color) ink is ejected from the nozzles 34 forming one nozzle array 36, while the complementary head 41 of this example is configured to be capable of ejecting inks of four colors, yellow (Y), magenta (M), cyan (C) and black (B).

That is, a flow channel unit 56H of the complementary head 41 is formed by laminating a nozzle plate 50H, a flow channel formation substrate 51H and a vibration plate 52H. The complementary nozzle array 40 formed in the nozzle plate 50H is formed by arranging unit complementary nozzle arrays 40Y, 40M, 40C and 40B, which eject the four yellow (Y), magenta (M), cyan (C) and black (B) color inks, in a line. In other words, the complementary nozzle array 40 is formed of four nozzle groups, which eject the four yellow (Y), magenta (M), cyan (C) and black (B) color inks. The nozzles of the unit complementary nozzle arrays 40Y, 40M, 40C and 40B are arrayed at a pitch P corresponding to a prescribed resolution (dot pitch) (which is a pitch equal to the pitch P of the nozzles 34 of the unit head 35).

Consequently, four kinds of pressure generating chambers 49Y 49M, 49C and 49B for ejecting the four color inks, and four damper chambers 45Y, 45M, 45C and 45B, and the like are formed corresponding to the unit complementary nozzle arrays 40Y, 40M, 40C and 40B which eject the four yellow (Y), magenta (M), cyan (C) and black (B) color inks.

Also, a head casing 46H is provided with four ink reservoirs (only one ink reservoir 47Y can be seen in the figure) and four ink supply paths 57Y, 57M, 57C and 57B, all of which correspond to the four yellow (Y), magenta (M), cyan (C) and black (B) color inks.

The complementary head 41 employs a vibrator unit 55 which is common to the vibrator unit 55 of the unit head 35.

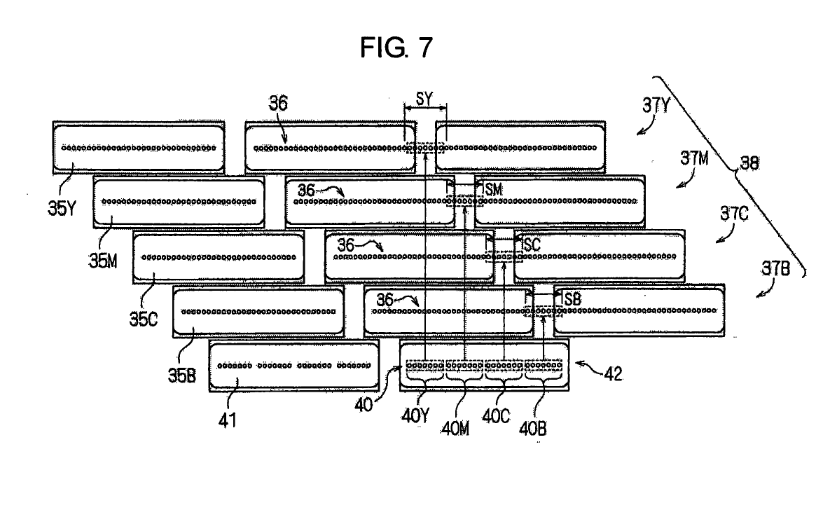

FIG. 7 shows details of the line head 3 formed of the unit head 35 and the complementary head 41.

In the line head 3, the yellow ink ejection head array 37Y is formed by arranging the unit heads 35Y, which eject the yellow ink, in series in the nozzle array 36 direction in such a way that the nozzle arrays 36 are arranged in one line at prescribed intervals. In the head array 37Y, each gap SY between the nozzle array 36 ends of adjacent unit heads 35Y having an equal dimension, is set so as to be about one fourth of one nozzle array 36 (equal to one of the number of kinds of inks ejected by the line head 3).

Similarly, the magenta ejection head array 37M is formed of the unit heads 35M which eject the magenta ink, the cyan ejection head array 37C is formed of the unit heads 35C which eject the cyan ink, and the black ejection head array 37B is formed of the unit heads 35B which eject the black ink. The four head arrays 37Y, 37M, 37C and 37B are arranged in such a way that the nozzle arrays 36 are parallel to each other.

The gap SY between the adjacent nozzle array 36 ends in the yellow ink head array 37Y, the gap SM between the adjacent nozzle array 36 ends in the magenta ink head array 37M, the gap SC between the adjacent nozzle array 36 ends in the cyan ink head array 37C, and the gap SB between the adjacent nozzle array 36 ends in the black ink head array 37B, having the same dimensions, are set so as to be about one fourth of one nozzle array 36 (equal to one of the number of kinds of inks ejected by the line head 3).

The yellow ink head array 37Y, the magenta ink head array 37M, the cyan ink head array 37C, and the black ink head array 37B are arranged in such a way that the adjacent head arrays 37Y, 37M, 37C and 37B are displaced by an amount equivalent to the gap SY, SM, SC, SB so that the gaps SY, SM, SC and SB in the respective head arrays 37Y, 37M, 37M and 37B do not overlap each other as seen in a direction perpendicular to the nozzle array 36.

The main head group 38 is formed of the individual color head arrays 37Y, 37M, 37C and 37B arranged as described heretofore.

The complementary head array 42 is formed by arranging the complementary heads 41 in series in a direction of the complementary nozzle array 40 (a complementary nozzle array 40 direction) in such a way that the complementary nozzle arrays 40 are arranged in one line at prescribed intervals. The complementary head array 42 is arranged in such a way that the nozzle arrays 36 of the four head arrays 37Y, 37M, 37C and 37B are parallel to the complementary nozzle arrays 40.

As described heretofore, the complementary nozzle array 40 of the complementary head 41 is formed by arranging, in one line, the unit complementary nozzle array 40Y which ejects the yellow ink, the unit complementary nozzle array 40M which ejects the magenta ink, the unit complementary nozzle array 40C which ejects the cyan ink, and the unit complementary nozzle array 40B which ejects the black ink. In other words, the complementary nozzle array 40 of the complementary head 41 is divided into a plurality of the unit complementary nozzle arrays 40Y, 40M, 40C and 40B which eject the individual inks which are ejected by the respective head arrays.

The unit complementary nozzle array 40Y, which ejects the yellow ink, is configured to, corresponding to the gap SY between the adjacent nozzle array 36 ends in the head array 37Y which ejects the yellow ink, eject ink droplets in the gap SY at the prescribed dot pitch P.

That is, the nozzles 34 of the nozzle array 36 of the unit head 35Y which ejects the yellow ink are arrayed at the prescribed dot pitch P, and the nozzles of the unit complementary nozzle array 40Y of the complementary head 41 which ejects the yellow ink are also arrayed at the prescribed dot pitch P. Furthermore, a distance in the nozzle array 36 (a nozzle array 36 direction distance) between the opposed nozzle array 36 ends of adjacent unit heads 35Y which eject the yellow ink, as well as a nozzle array 36 direction distance between the nozzles 34 at both ends of the unit complementary nozzle array 40Y corresponding to the gap SY sandwiched between the opposed ends, is an amount of space in which the nozzles 34 are arrayed at the prescribed dot pitch P.

Similarly, a nozzle array 36 direction distance between the opposed nozzle array 36 ends of adjacent unit heads 35M which eject the magenta ink, as well as a nozzle array 36 direction distance between the nozzles 34 at both ends of the unit complementary nozzle array 40M corresponding to the gap SM sandwiched between the opposed ends, is an amount of space in which the nozzles 34 are arrayed at the prescribed dot pitch P.

A nozzle array 36 direction distance between the opposed nozzle array 36 ends of adjacent unit heads 35C which eject the cyan ink, as well as a nozzle array 36 direction distance between the nozzles 34 at both ends of the unit complementary nozzle array 40C corresponding to the gap SC sandwiched between the opposed ends, is an amount of space in which the nozzles 34 are arrayed at the prescribed dot pitch P.

A nozzle array 36 direction distance between the opposed nozzle array 36 ends of adjacent unit heads 35B which eject the black ink, as well as a nozzle array 36 direction distance between the nozzles 34 at both ends of the unit complementary nozzle array 40B corresponding to the gap SB sandwiched between the opposed ends, is an amount of space in which the nozzles 34 are arrayed at the prescribed dot pitch P.

That is, the gap SY, SM, SC, SB between the nozzle arrays 36 of adjacent unit heads 35Y 35M, 35C, 35B, which form each of the head arrays 37Y, 37M, 37C and 37B forming the main head group 38, is set to have substantially the same length as the unit complementary nozzle array 40Y 40M, 40C, 40B of the complementary head 41. Particularly, a dimension of each gap SY, SM, SC, SB in the nozzle array 36 direction is set at a length obtained by adding a dimension of the dot pitch P×2 to the length of each unit complementary nozzle array 40Y 40M, 40C, 40B.

Consequently, each nozzle array 36 belonging to the head array 37Y which ejects the yellow ink, and the yellow ink ejection unit complementary nozzle array 40Y of the complementary head 41 can form a dot matrix at the prescribed dot pitch P.

Similarly, each nozzle array 36 belonging to the head array 37M which ejects the magenta ink, and the magenta ink ejection unit complementary nozzle array 40M of the complementary head 41 can form a dot matrix at the prescribed dot pitch P.

Each nozzle array 36 belonging to the head array 37C which ejects the cyan ink, and the cyan ink ejection unit complementary nozzle array 40C of the complementary head 41 can form a dot matrix at the prescribed dot pitch P.

Each nozzle array 36 belonging to the head array 37B which ejects the black ink, and the black ink ejection unit complementary nozzle array 40B of the complementary head 41 can form a dot matrix at the prescribed dot pitch P.

At this point, the sum of each gap SY, SM, SC, SB between the nozzle arrays 36 of adjacent unit heads 35Y, 35M, 35C, 35B, which form each of the head arrays 37Y, 37M, 37C and 37B in the main head group 38, is set to be equal to or less than the length of the complementary nozzle array 40 of the complementary head 41, and the complementary head 41 and the unit heads 35 are set to have the same size.

That is, each gap SY, SM, SC, SB between adjacent nozzle arrays 36 in each of the head arrays 37Y, 37M, 37C and 37B is set so as to be about one fourth of one nozzle array 36 (equal to one of the number of kinds of inks ejected by the line head 3). Also, the nozzle array 36 of the unit head 35 and the complementary nozzle array 40 of the complementary head 41 are set to have substantially the same length. The unit complementary nozzle arrays 40Y 40M, 40C and 40B of the complementary head 41 are each set so as to be about one fourth (equal to one of the number of kinds of inks ejected by the line head 3) of the complementary nozzle array.

According to the above configuration, in the recording apparatus, instead of forming a chip line by staggering head chips, as a plurality of ejecting lines is formed in such a way that a gap between adjacent nozzle arrays 36 in each of a plurality of the head arrays 37Y, 37M, 37C and 37B is complemented by one complementary head array 42, it is sufficient to provide one complementary head array 42 in addition to the plurality of head arrays 37Y, 37M, 37C and 37B which forms the main head group 38. Consequently, it is possible to significantly reduce the width of the head unit 3 as compared with the staggered arrangement of the related ink ejecting head.

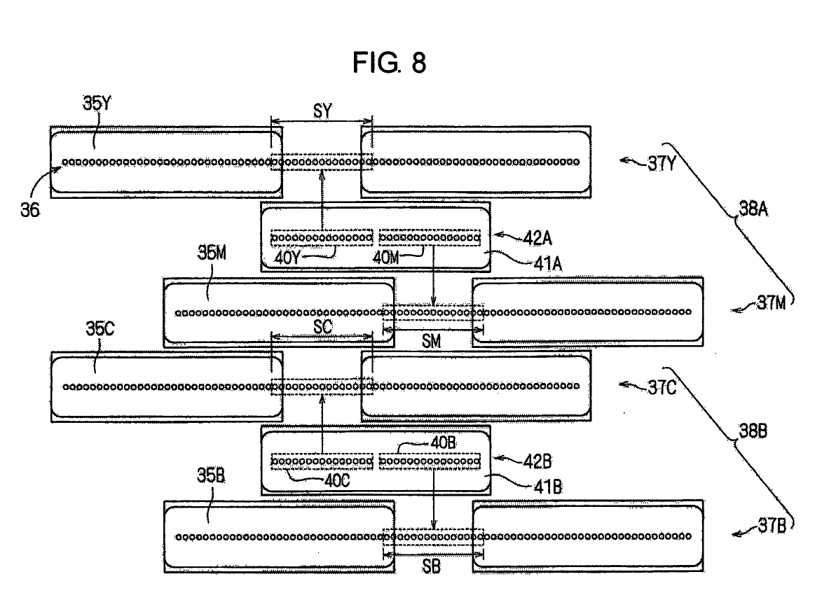

FIG. 8 shows a second example of the recording apparatus to which the invention is applied.

In the first example described heretofore, a configuration is such that the main head group 38 is formed of the four head arrays 37Y, 37M, 37C and 37B, the yellow ink head array 37Y, the magenta ink head array 37M, the cyan ink head array 37C, and the black ink head array 37B, and the four color inks are ejected from the complementary head 41.

In the second example, a configuration is such that a first main head group 38A is formed of the yellow ink head array 37Y and the magenta ink head array 37M, and the yellow ink and the magenta ink are ejected from a first complementary head 41A, while a second main head group 38B is formed of the cyan ink head array 37C and the black ink head array 37B, and the cyan ink and the black ink are ejected from a second complementary head 41B.

That is, the complementary nozzle array 40 of the first complementary head 41A is formed of the unit complementary nozzle array 40Y which ejects the yellow ink and the unit complementary nozzle array 40M which ejects the magenta ink. The complementary nozzle array 40 of the second complementary head 41B is formed of the unit complementary nozzle array 40C which ejects the cyan ink and the unit complementary nozzle array 40B which ejects the black ink.

In a first main group 38A, the gap SY between adjacent nozzle arrays 36 in the yellow ink ejection head array 37Y is complemented by the unit complementary nozzle array 40Y of the first complementary head 41A, and the gap SM between adjacent nozzle arrays 36 in the magenta ink ejection head array 37M is complemented by the unit complementary nozzle array 40M of the first complementary head 41A. Also, in a second main head group 38B, the gap SC between adjacent nozzle arrays 36 in the cyan ink ejection head array 37C is complemented by the unit complementary nozzle array 40C of the second complementary head 41B, and the gap SB between adjacent nozzle arrays 36 in the black ink ejection head array 37B is complemented by the unit complementary nozzle array 40B of the second complementary head 41B.

Also, in this example, a first complementary head array 42A of the first complementary head 41A is disposed between two head arrays 37Y and 37M which form the first main head group 38A, and a second complementary head array 42B of the second complementary head 41B is disposed between two head arrays 37C and 37B which form the second main head group 38B.

Apart from that, this example is the same as the first example, and provides the similar advantageous effect.

Although a description given heretofore has shown an example in which the invention is applied to the line head 3, the invention is not limited to it, but can also be applied to a serial head. That is, in a head unit to be mounted on a carriage which reciprocates in a paper width direction of the recording paper, unit heads are arranged in series in a sub-scanning direction which is the paper transport direction, thereby increasing the number of nozzles in the sub-scanning direction, whereby such a head unit can also be applied to a serial head which carries out a high speed printing.

According to the above configuration, the invention includes: a head array 37Y, 37M, 37C, 37B being formed by arranging unit heads 35Y, 35M, 35C, 35B in series in a nozzle array 36 direction; a main head group 38 being formed by arranging the head arrays 37Y, 37M, 37C and 37B with the unit heads 35Y, 35M, 35C and 35B displaced by an amount equivalent to a gap SY, SM, SC, SB between the nozzle arrays 36 of adjacent unit heads 35Y, 35M, 35C, 35B; and a complementary head 41 which ejects inks so as to complement the gap SY, SM, SC, SB between the adjacent nozzle arrays in each of the head arrays 37Y, 37M, 37C and 37B in the main head group 38. In this way, instead of forming a chip line by staggering head chips as used in the related art, as a plurality of ejecting lines is formed in such a way that a gap between adjacent nozzle arrays 36 in each of a plurality of head arrays 37Y 37M, 37C and 37B is complemented by one complementary head array 42, it is sufficient to provide one complementary head array 42 in addition to the plurality of head arrays 37Y, 37M, 37C and 37B which forms the main head group 38. Consequently, it is possible to significantly reduce the width of the head unit as compared with the heretofore known staggered arrangement.

Also, a plurality of the head arrays is provided, one for each kind of liquid to be ejected, and a complementary nozzle array of the complementary head is configured to eject a plurality of kinds of liquids, which are ejected from the individual head arrays. Therefore, instead of preparing a number of head arrays twice the number of kinds of liquids as in the heretofore known staggered arrangement, a head unit can be formed of a number of head arrays equivalent to only the number of kinds of liquids and one complementary head array, thus enabling a significant reduction in the width of the head unit.

Also, the complementary nozzle array 40 of the complementary head 41 is divided into a plurality of unit complementary nozzle arrays 40Y, 40M, 40C and 40B which eject the inks, which are ejected from the individual head arrays. Therefore, it is possible to simplify the structure of the complementary head 41 and avoid an unnecessary increase in cost.

Also, the gap SY, SM, SC, SB between the nozzle arrays 36 of adjacent unit heads 35Y, 35M, 35C, 35B which form each of the head arrays 37Y, 37M, 37C and 37B forming the main head group 38 is set to have substantially the same length as the unit complementary nozzle array 40Y, 40M, 40C, 40B of the complementary head 41. Therefore, the arrangement of the head arrays 37Y, 37M, 37C and 37B formed of a plurality of the unit heads 35Y, 35M, 35C and 35B, as well as the arrangement of the unit heads 35Y, 35M, 35C and 35B in the main head group 38 formed of the head arrays 37Y, 37M, 37C and 37B, can be simplified and, moreover, the structure of the complementary head 41 can also be simplified. Thus, the overall structure can be simplified, thereby avoiding an unnecessary increase in cost.

Also, the sum of each gap between the nozzle arrays 36 of adjacent unit heads 35Y, 35M, 35C, 35B which form each of the head arrays in the main head group is set to be equal to or less than the length of the complementary nozzle array 40 of the complementary head 41, and the complementary head 41 and the unit heads 35 are set to have the same size. In this case, parts can be shared between the unit heads 35 and the complementary head 41.

Also, the head arrays 37Y, 37M, 37C and 37B, being arranged extending in a width direction of a target object, form a line head having the nozzles arranged all over the width of an ejecting area. In this case, in the liquid ejecting apparatus having the line head, it is possible to reduce a dimension of the line head in a transport direction of the target object and reduce the size of the apparatus.

Also, the head arrays, being arranged extending in a transport direction of a target object such as the recording paper 9, form a serial head which carries out an ejecting while causing the head arrays to reciprocate in the width direction of the target object. In this case, it is possible to reduce a dimension of the serial head in a main scanning direction and reduce the size of the apparatus.

The invention can be applied to a liquid ejecting apparatus and, as its representative example, there is an inkjet recording apparatus equipped with an inkjet recording head for image recording. Other examples of the liquid ejecting apparatus include an apparatus equipped with a color material ejecting head for use in manufacturing a color filter for a liquid crystal display or the like, an apparatus equipped with an electrode material (electrically conductive paste) ejecting head for use in forming an electrode for an organic light emitting display, a surface emitting display (FED) or the like, an apparatus equipped with a living organic material ejecting head for use in manufacturing biochips, an apparatus equipped with a sample ejecting head as a precision pipette, and the like.

What is claimed is:

1. A liquid ejecting apparatus comprising:
a head group, including:
a first array, including:
a first nozzle array and a second nozzle array, each of which is operable to eject first liquid and extends in a first direction, and which are arranged in the first direction and define a first gap therebetween; and
a second array including:
a third nozzle array and a fourth nozzle array, each of which is operable to eject second liquid and extends in the first direction, and which are arranged in the first direction and define a second gap therebetween;
wherein the first and second arrays are arranged in a second direction perpendicular to the first direction, and
wherein the first and second gaps are not overlapped in the second direction; and
a fifth nozzle array, operable to eject the first and second liquid and disposed so as to correspond to the first and second gaps in the second direction.

2. The liquid ejecting apparatus according to claim 1, wherein
the first liquid is different from the second liquid.

3. The liquid ejecting apparatus according to claim 2, wherein
the fifth nozzle array includes a sixth nozzle array operable to eject the first liquid and a seventh nozzle array operable to eject the second liquid which are arranged in the first direction.

4. The liquid ejecting apparatus according to claim 3, wherein
length of the first gap is substantially identical with length of the sixth nozzle array, and
length of the second gap is substantially identical with length of the seventh nozzle array.

5. The liquid ejecting apparatus according to claim 1, wherein
sum of length of the first gap and length of the second gap is no more than length of the fifth nozzle array, and
size of each of unit heads, which have the first, second, third and fourth nozzle arrays, respectively, is identical with size of a complementary head having the fifth nozzle array.

6. The liquid ejecting apparatus according to claim 1, wherein
a plurality of the head groups are arranged in the first direction.

7. The liquid ejecting apparatus according to claim 1, wherein
a plurality of the head groups are arranged in the second direction.
